(19) United States
(12) Patent Application Publication
(10) Pub. No.: US 2004/0179321 A1
(43) Pub. Date: Sep. 16, 2004

(54) Degaussing circuit for cathode ray tube

(76) Inventors: Tok-Chin Woo, Suwon-city (KR); Joon-Suk Park, Kunpot-city (KR)

Correspondence Address: Robert E. Bushnell, Suite 300, 1522 K Street, N.W., Washington, DC, 20005, US

(21) Appl. No.: 10/756,286

(22) Filed: Jan. 14, 2004

(30) Foreign Application Priority Data
Mar. 11, 2003 (KR) 2003-15155
Mar. 11, 2003 (KR) 2003-15156

(51) Int. Cl. H01H 47/00

(52) U.S. Cl. 361/150

(57) ABSTRACT

A CRT (cathode-ray tube) degaussing circuit comprises: an AC (alternating current) power source; a PTC (positive temperature characteristic) resistor; a heat sense switch, provided as a single unit with the PTC resistor for controlling the current flow of the entire circuit so as to be turned on/off according to a surface temperature of the PTC resistor; and a degaussing coil for demagnetizing metallic components of the CRT when the current is applied. The AC power source, the PTC resistor, the degaussing coil, and the heat sense switch form a closed-loop circuit, and the heat sense switch is connected thereto so as to turn on/off the current flow in the closed-loop circuit.

### CLAIM OF PRIORITY

This application makes reference to, incorporates the same herein, and claims all benefits accruing under 35 U.S.C. § 119 from applications both entitled DEGAUSSING CIRCUIT FOR CATHODE RAY TUBE earlier filed in the Korean Intellectual Property Office on 11 Mar. 2003 and thereby duly assigned Serial No.2003-15155 and filed on 11 Mar. 2003 and thereby duly assigned Serial No. 2003-15156.

### BACKGROUND OF THE INVENTION

1. Technical Field

The present invention relates to a cathode ray tube and, more particularly, to a cathode ray tube that uses a degaussing coil for demagnetizing metal parts in the cathode ray tube such as a color selection apparatus and an inner shield.

2. Related Art

In general, steel components installed in a CRT comprise: a shadow mask, including a plurality of apertures, for separating three kinds of electron beams outputted by an electron gun onto corresponding RGB (red, green, and blue) phosphors on a phosphor-coated screen; a color selection apparatus including a mask frame for fixing and supporting the shadow mask; and an inner shield mounted on the mask frame to mask paths of the electron beams outputted by the electron gun from the earth's magnetic field.

However, the steel components are magnetized by the earth's magnetic field to form magnetic fields around the steel components, and the magnetic fields change progress paths of the electron beams that proceed in the CRT. This phenomenon prevents the electron beams from reaching specified phosphors (referred to as “mislanding” hereinafter), and the mislanding is a factor in substantially lowering screen display quality.

To solve this problem, a degaussing coil is attached on an external circumference of a funnel of the CRT, and the degaussing coil demagnetizes the color selection apparatus and the inner shield according to a demagnetization current supplied for three to four seconds each time the power is supplied. Conventional color selection apparatuses use PTC (positive temperature characteristic) resistors which generate heat when a current is applied to them, and the resistance thereof increases because of the heat, thereby gently reducing the supplied current. Demagnetization efficiency is closely related to a gently reducing AC current format. Therefore, an appropriate demagnetization operation depends mainly on features of the PTC resistors used for the degaussing circuit. In particular, if the PTC resistor is not sufficiently cooled for more than ten minutes after its operation, the appropriate AC current format is broken to magnetize the color selection apparatus and the inner shield. Also, since the demagnetization process is finished in two to three seconds, the demagnetization operation time is controlled to intercept the demagnetization current flowing to the degaussing coil for ten minutes, thereby preventing problems such as screen flickers caused by fine leakage current flowing to the degaussing coil after the completion of demagnetization.

A degaussing circuit comprises an AC power source, a timer, a microcomputer, a relay, a PTC resistor unit, and a degaussing coil. The AC power source is coupled to supply the AC power to the degaussing coil through the relay and the PTC resistor unit. The PTC resistor unit comprises two PTC resistors coupled in parallel.

The microcomputer controls on/off timing of the relay referring to time from the timer. That is, when a demagnetization operation is needed, the timer turns on the relay to supply the current to the PTC resistor unit and the degaussing coil from the AC power source. Since the demagnetization operation is finished in two to three seconds, the microcomputer turns off the relay based on the time measured by the timer, e.g., when ten seconds have passed. When the relay is turned off, supply of the demagnetization current to the PTC resistor unit is intercepted, and the PTC resistor unit is cooled. It requires at least ten to fifteen minutes to sufficiently cool the PTC resistor unit, and hence, the microcomputer controls the relay so that it is not turned on within the time frame. Since the configuration of the degaussing circuit is very complicated, and since it has expensive components, the overall cost is increased.

The AC power used for the degaussing circuit can be either 110V or 220V, and specifications of a degaussing coil and a degaussing circuit are designed to be appropriate for either AC voltage, since some areas or nations use both voltages. However, since a CRT that uses a tension mask requires 1.5 to 2 times the EMF (electromotive force) of the CRT, it is impossible to design the degaussing coil and the degaussing circuit to concurrently satisfy the two voltage conditions of 110V and 220V.

Table 1 shows power data required by a CRT and a CRT using a tension mask.

TABLE 1

| | Input | Demagnetization | Demagnetization | |
|---|---|---|---|---|
| | voltage (V) | EMF (AT) | current (A) | Remarks |
| General CRT | 110 | 2,500 | 17 | Common |
| | 220 | 5,000 | 34 | application |
| | | | | condition for |
| | | | | degaussing |
| | | | | circuit of 110 V |
| Tension mask | 110 | 5,000 | 25 | Common |
| CRT | 220 | 10,000 | 50 | application |
| | | | | condition for |
| | | | | degaussing |
| | | | | circuit of 110 V |

<AT: Ampere turn>

As shown in Table 1, when designing the degaussing coil and the degaussing circuit satisfying the two voltage conditions of 110V and 220V, the demagnetization is designed on the basis of the condition of 110V in the general CRT case. Usage of 220V requires twice the EMF as compared to use of 110V, but no load occurs, and accordingly, the design based on use of 110V can also be used without modification. This is possible because the maximum demagnetization current given to the design of the degaussing circuit does not exceed 40 A.

However, since the CRT using a tension mask requires twice the EMF compared to that of the general CRT, if 220V are applied to the degaussing circuit designed for the AC voltage of 110V and the demagnetization EMF of 5,000 AT, the demagnetization EMF becomes 10,000 AT and the demagnetization current becomes 50 A. Thus, a substantial load is provided to the degaussing circuit, and a lot of demagnetization EMF is generated, which causes problems with respect to a mobile quantity of the magnetic fields. Therefore, when the demagnetization design of the CRT in which a tension mask is used is executed according to a voltage condition of 220V so as to solve the above-noted problem, the demagnetization EMF is reduced to half when the voltage of 110V is applied, and hence an appropriate demagnetization function does not operate. Therefore, if no additional control system is added to the degaussing circuit, it is impossible to design the degaussing coil and the degaussing circuit to satisfy the conditions of the two voltages 110V and 220V in the CRT using a tension mask.

Accordingly, a degaussing circuit to diverge to a 110V path and a 220V path according to a voltage of an AC power is used in the CRT using a tension mask. That is, a second degaussing circuit comprises an AC power source, a microcomputer for controlling switching states, a switch controlled by the microcomputer, a PTC resistor forming a first path, resistors and PTC resistors forming a second path, and a capacitor C and a degaussing coil coupled in common to the first and second paths. The microcomputer controls the switch to select one of the first and second paths according to a voltage of the AC power source. That is, the first path is selected when the voltage of the AC power unit is 110V, and the second path is selected when the voltage of the AC power unit is 220V. Resistance values of the resistors and the PTC resistors are designed for the first and second paths so as to obtain necessary demagnetization EMF when the voltages of 110V and 220V are respectively applied.

However, since the above-described degaussing circuit senses whether the voltage of the AC power is 110V or 220V, and uses the microcomputer to select a current path according to a sensed result, the degaussing circuit becomes complicated, and the product cost rises because of usage of expensive components.

Another type of degaussing circuit comprises an AC power source, a filter block for preventing noise generated in the degaussing circuit from being fed back to the AC power source, a voltage detector for detecting whether the voltage of the AC power source is 110V or 220V, a relay driver and a relay controlled by the voltage detector, a PTC resistor forming a first path, a resistor and a PTC resistor forming a second path, a capacitor C and a degaussing coil coupled in common to the first and second paths and coupled in parallel with each other, a timer, a microcomputer, and a relay driver and a relay controlled by the microcomputer.

The voltage detector controls the relay driver so that the relay may select one of the first and second paths according to voltage of the AC power source. That is, the first path is selected when the voltage of the AC power source is 110V, and the second path is selected when the voltage of the AC power source is 220V. Resistance values of the resistor and the PTC resistors are designed for the first and second paths so as to obtain necessary demagnetization EMF when the voltages of 110V and 220V are respectively applied.

However, the degaussing circuit senses whether the voltage of the AC power source is 110V or 220V, and uses an additional voltage detector and a relay driver so as to select a corresponding current path. Also, the microcomputer controls on/off timing of the relay as a result of the relay driver referring to time from the timer. That is, when a demagnetization operation is needed, the microcomputer controls the relay driver according to time from the timer so as to turn on the relay. When the relay is turned on, the current for the demagnetization operation is applied by the AC power source to the PTC resistor or the PTC resistor and the degaussing coil. Since the demagnetization operation is finished within two to three seconds, the microcomputer turns off the relay based on the time measured by the timer, for example, when ten seconds have passed. Supply of the demagnetization current to one of the PTC resistors is intercepted, and the PTC resistor is cooled when the relay is turned off. Since the PTC resistors require at least ten to fifteen minutes for sufficient cooling, the microcomputer controls the relay so as not to be turned on within this time frame. However, the configuration of the degaussing circuit is very complex such that it occupies a large portion of the circuitry space, and this raises production cost because of usage of expensive components.

### SUMMARY OF THE INVENTION

It is an advantage of the present invention to provide a degaussing circuit which eliminates the need for a microcomputer to control operation time and cooling time of PTC resistors, a timer, and a relay so as to reduce or eliminate expensive components and lower production cost. The demagnetization operation time is controlled to be within ten seconds by using a heat sensing switch attached to the PTC resistor, while concurrently obtaining a sufficient cooling time.

In one aspect of the present invention, the CRT degaussing circuit comprises: an AC power source; a PTC resistor; a heat sense switch, provided as a single unit with the PTC resistor, for controlling the current flow of the entire circuit so that it is turned on/off according to a surface temperature of the PTC resistor; and a degaussing coil for demagnetizing metallic components of the CRT when the current is applied.

The AC power source, the PTC resistor, the degaussing coil, and the heat sense switch form a closed-loop circuit, and the heat sense switch is connected thereto so as to turn on/off the current flow of the closed-loop circuit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a first degaussing circuit for a CRT;

FIG. 2 shows a second degaussing circuit for a CRT;

FIG. 3 shows a third degaussing circuit for a CRT;

FIG. 4 shows a degaussing circuit for a CRT according to a first preferred embodiment of the present invention;

FIG. 5 shows a degaussing circuit for a CRT according to a second preferred embodiment of the present invention;

FIGS. 6 and 7 show the degaussing circuit of FIG. 5 when the AC voltages are 110V and 220V, respectively;

FIG. 8 shows a degaussing circuit for a CRT according to a second preferred embodiment of the present invention; and

FIGS. 9 thru 11 show the degaussing circuit of FIG. 8 when the AC voltage is 110V, when the AC voltage is 220V, and when a heat sense switch operates with the voltage of 220V, respectively.

### DETAILED DESCRIPTION OF THE PREFERRED EMBODIMENTS

In the following detailed description, only the preferred embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

Before describing a degaussing circuit according to preferred embodiments of the present invention, a general CRT to which the degaussing circuit is applied will be described. The CRT comprises: a face plate including a phosphor dot screen, with skirts extending vertically from four edges of the phosphor dot screen; a funnel and a neck connected to the rear of the face plate; a color selection apparatus facing the phosphor dot screen and mounted in the face plate; an inner magnetic shield provided on the rear of the color selection apparatus, and located in the funnel; a pair of face plate degaussing coils respectively installed on the long-side skirts of the face plates and corresponding to the color selection apparatus; and a funnel degaussing coil provided as a single body along the outer circumference of the funnel with respect to the neck and corresponding to the inner magnetic shield.

In the above-configured CRT, the face plate degaussing coil is preferably provided following the edge of the long-side skirt in a circular or square manner. The funnel degaussing coil, having a figure eight shape or having a top/down separable format, is preferably provided along the outer circumference of the face plate, and covering a wide area thereof.

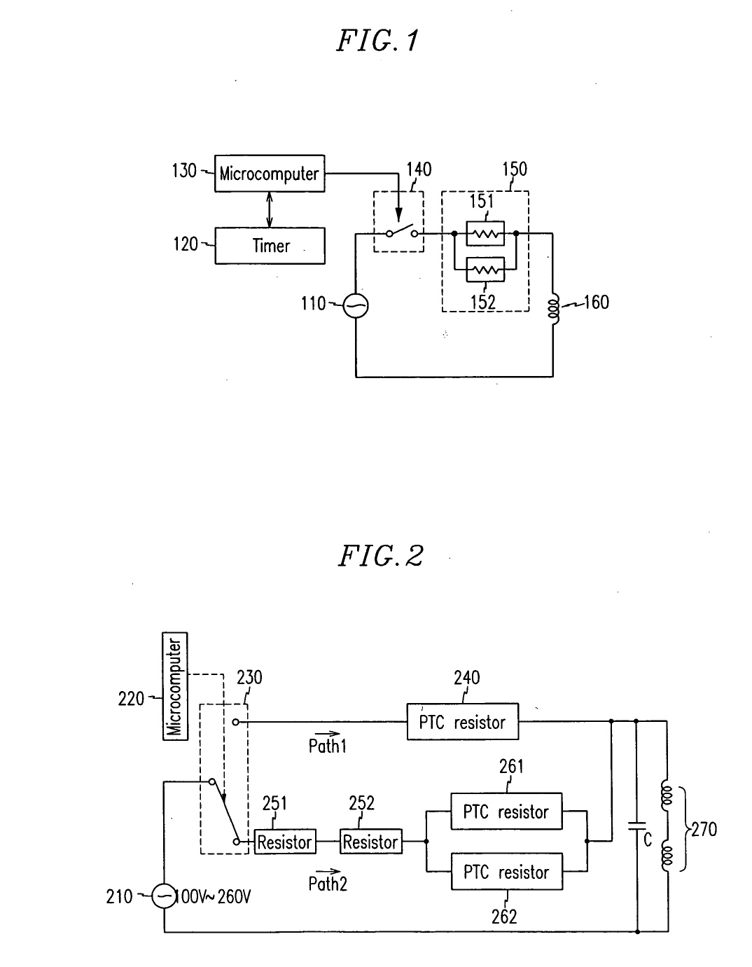

FIG. 1 shows a degaussing circuit for a CRT. As shown, the degaussing circuit comprises an AC power source 110, a timer 120, a microcomputer 130, a relay 140, a PTC resistor unit 150, and a degaussing coil 160. The AC power source 110 is coupled to supply AC power to the degaussing coil 160 through the relay 140 and the PTC resistor unit 150. The PTC resistor unit 150 comprises two PTC resistors 151 and 152 coupled in parallel.

The microcomputer 130 controls on/off timing of the relay 140 referring to time from the timer 120. That is, when a demagnetization operation is needed, the microcomputer 130 with timer 120 turns on the relay 140 to supply current to the PTC resistor unit 150 and the degaussing coil 160 from the AC power source 110. Since the demagnetization operation is finished in two to three seconds, the microcomputer 130 turns off the relay 140 based on the time measured by the timer 120, (e.g., when ten seconds have passed). When the relay 140 is turned off, supply of the demagnetization current to the PTC resistor unit 150 is interrupted, and the PTC resistor unit 150 is cooled. It requires at least ten to fifteen minutes to sufficiently cool the PTC resistor unit 150, and hence, the microcomputer 130 controls the relay 140 so as not to be turned on within that time frame. Since the configuration of the degaussing circuit is very complicated and it has expensive components, it has a cost which is undesirably high.

The AC power used for the degaussing circuit can be either 110V or 220V, and specifications of a degaussing coil and a degaussing circuit are designed to be appropriate for either AC voltage, since some areas or nations use both voltages. However, since a CRT that uses a tension mask requires 1.5 to 2 times the EMF (electromotive force) of the conventional CRT, it is impossible to design the degaussing coil and the degaussing circuit to concurrently satisfy the two voltage conditions of 110V and 220V.

Table 2 shows power data required by a conventional CRT and a CRT using a tension mask.

TABLE 2

| | Input | Demagnetization | Demagnetization | |
|---|---|---|---|---|
| | voltage (V) | EMF (AT) | current (A) | Remarks |
| General CRT | 110 | 2,500 | 17 | Common |
| | 220 | 5,000 | 34 | application |
| | | | | condition for |
| | | | | degaussing |
| | | | | circuit of 110 V |
| Tension mask | 110 | 5,000 | 25 | Common |
| CRT | 220 | 10,000 | 50 | application |
| | | | | condition for |
| | | | | degaussing |
| | | | | circuit of 110 V |

<AT: Ampere turn>

As shown in Table 2, when designing the degaussing coil and the degaussing circuit to satisfy the two voltage conditions of 110V and 220V, the demagnetization is designed on the basis of the condition of 110V in the general CRT case. Usage of 220V requires twice the EMF of the case of using 110V, but no load occurs, and accordingly, the design based on the condition of 110V can also be used without modification. This is possible because the maximum demagnetization current for the design of the degaussing circuit does not exceed 40 A.

However, since the CRT using a tension mask requires twice the EMF of the general CRT, if 220V are applied to the degaussing circuit designed for an AC voltage of 110V and a demagnetization EMF of 5,000 AT, the demagnetization EMF becomes 10,0000 AT and the demagnetization current becomes 50 A. Thus, a substantial load is provided to the degaussing circuit, and a lot of demagnetization EMF is generated, which causes problems with respect to a mobile quantity of the magnetic fields. Therefore, when the demagnetization design of the CRT in which a tension mask is used is executed according to a voltage condition of 220V so as to solve the above-noted problem, the demagnetization EMF is reduced to half when the voltage of 110V is applied, and hence an appropriate demagnetization function is not carried out. Therefore, if no additional control system is added to the degaussing circuit, it is impossible to design the degaussing coil and the degaussing circuit to satisfy the conditions of the two voltages 110V and 220V in the CRT using a tension mask.

FIG. 2 shows a second degaussing circuit for a CRT. As shown in FIG. 2, a degaussing circuit to diverge to a 110V path and a 220V path according to the AC voltage is used in a CRT which employs a tension mask. The second degaussing circuit comprises an AC power source 210, a microcomputer 220 for controlling switching states, a switch 230 controlled by the microcomputer 220, a PTC resistor 240 forming a first path, resistors 251 and 252 and PTC resistors 261 and 262 forming a second path, and a capacitor C and a degaussing coil 270 coupled in common to the first and second paths. The microcomputer 220 controls the switch 230 to select one of the first and second paths according to a voltage of the AC power source 210. That is, the first path (Path 1 in FIG. 2) is selected when the voltage of the AC power unit 210 is 110V, and the second path (Path 2 in FIG. 2) is selected when the voltage of the AC power unit 210 is 220V. Resistance values of the resistors 251 and 252 and the PTC resistors 240, 261, and 262 are designed for the first and second paths so as to obtain necessary demagnetization EMF when the voltages of 110V and 220V are respectively applied.

However, since the above-described degaussing circuit senses whether the voltage of the AC power is 110V or 220V, and uses the microcomputer to select a current path according to the sensed result, the degaussing circuit is complicated, and the product cost rises because of the need to use expensive components.

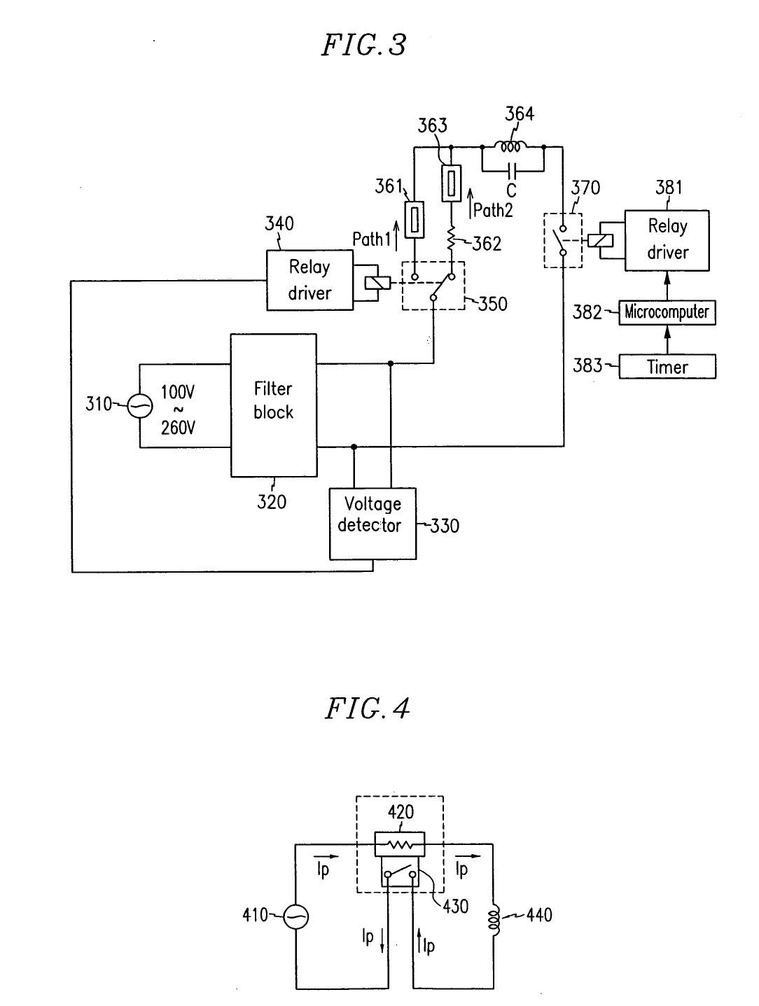

FIG. 3 shows a third degaussing circuit for a CRT. As shown, the third degaussing circuit comprises: an AC power source 310; a filter block 320 for preventing noise generated in the degaussing circuit from being fed back to the AC power source 310; a voltage detector 330 for detecting whether the voltage of the AC power source 310 is 110V or 220V; a relay driver 340 and a relay 350 controlled by the voltage detector 330; a PTC resistor 361 forming a first path (Path in FIG. 3); a resistor 362 and a PTC resistor 363 forming a second path (Path 2 in FIG. 3); a capacitor C and a degaussing coil 364 coupled in common to the first and second paths, and coupled in parallel with each other; a timer 383; a microcomputer 382; and a relay driver 381 and a relay 370 controlled by the microcomputer 382.

The voltage detector 330 controls the relay driver 340 so that the relay 350 selects one of the first and second paths according to the voltage of the AC power source 310. That is, the first path is selected when the voltage of the AC power source 310 is 110V, and the second path is selected when the voltage of the AC power source 310 is 220V. Resistance values of the resistor 362 and the PTC resistors 361 and 363 are designed for the first and second paths so as to obtain necessary demagnetization EMF when the voltages of 110V and 220V are respectively applied.

However, the degaussing circuit of FIG. 3 senses whether the voltage of the AC power source 310 is 110V or 220V, and uses an additional voltage detector 330 and a relay driver 340 so as to select a corresponding current path. Also, the microcomputer 382 controls on/off timing of the relay 370 through the relay driver 381 referring to time from the timer 383. That is, when a demagnetization operation is needed, the microcomputer 382 controls the relay driver 381 according to time from the timer 383 so as to turn on the relay 370. When the relay 370 is turned on, the current for the demagnetization operation is applied by the AC power source 310 to the PTC resistor 361 or the PTC resistor 363 and the degaussing coil 364. Since the demagnetization operation is finished within two to three seconds, the microcomputer 382 turns off the relay 370 based on the time measured by the timer 383, for example, when ten seconds have passed. Supply of the demagnetization current to one of the PTC resistors 361 and 363 is interrupted, and the PTC resistor 361 or 363 is cooled when the relay 370 is turned off. Since the PTC resistors 361 and 363 require at least ten to fifteen minutes for sufficient cooling, the microcomputer 382 controls the relay 370 so as not to be turned on within this time frame. However, the configuration of the degaussing circuit is very complex such that it occupies a large portion of the circuitry space and raises production cost because of the use of expensive components.

Referring to FIG. 4, a CRT degaussing circuit according to a first preferred embodiment of the present invention will be described.

As shown in FIG. 4, the CRT degaussing circuit comprises an AC power source 410, a PTC resistor 420, a heat sense switch 430 attached to the PTC resistor 420 so as to form a single unit, and a degaussing coil 440 for degaussing metallic components of the CRT. The AC power source 410, the PTC resistor 420, the heat sense switch 430, and the degaussing coil 440 form a closed-loop circuit, and the heat sense switch 430 is connected therein so as to turn on/off the current flow in the closed-loop circuit. The current transfer path of the closed-loop circuit is in the order of the AC power source 410, the PTC resistor 420, the degaussing coil 440, and the heat sense switch 430.

As to operation of the circuit, when the CRT starts its operation, and the AC power source 410 supplies power, current flows to the PTC resistor 420 and the degaussing coil 440. In this instance, when the current flows to the PTC resistor 420, the PTC resistor 420 is heated so as to raise its temperature. When the current continuously flows thereto, the resistance of the PTC resistor 420 increases, and the current finally becomes almost zero. The heat sense switch 430 is turned on in the initial cooled state so that the current flows to the circuit. The current continuously flows to the circuit to heat the PTC resistor 420, and in some cases, the surface temperature of the PTC resistor 420 instantly and steeply rises. The heat sense switch 430 is turned off when the temperature of the PTC resistor 420 exceeds a switch operation temperature, thereby interrupting the current flow in the degaussing circuit. The heat sense switch 430 remains turned off until the PTC resistor 420 is cooled so as to reduce the surface temperature thereof below a predetermined condition.

The above-described degaussing circuit according to the preferred embodiment of the present invention is applied to the color selection apparatus of a CRT, wherein the color selection apparatus comprises a tension mask having a plurality of apertures and providing tension force in the short side direction of the face plate, and a mask frame having a pair of support members for supporting the long side of the tension mask and a pair of elastic members for connecting the support members into a single body in the short side direction.

Next, experimental results as to the relationship between the time during which current flows to the PTC resistor 420 and the surface temperature will be described.

The AC power source 410 is 220V at 60 Hz, internal resistance of the degaussing coil 440 is 17Ω, and the PTC resistor 420 has resistance of 4.5Ω. The magnetomotive force of the AC magnetic field decay in this instance is 5,000 AT.

Table 3 shows the relationship between the time during which current flows to the PTC resistor 420 and its surface temperature.

TABLE 3

| | Current flow time | | | | | |
|---|---|---|---|---|---|---|
| | to PTC resistor (sec) | | | | | |
| | 10 | 20 | 30 | 60 | 120 | 180 |
| Surface temperature of PTC resistor | 41 | 45 | 49 | 57 | 66 | 72 |
| (C.°) | | | | | | |

Referring to Table 3, when the current flows to the PTC resistor 420 for about 10 seconds, its surface temperature already exceeds 41° C. Therefore, the heat sense switch 430 operates to turn off the circuit. In this instance, since the operational temperature of the heat sense switch 430 ranges from 20 to 60° C. depending on specifications of manufacturers, any heat sense switch appropriate for the degaussing circuit according to the first preferred embodiment can be used. Also, after the surface temperature of the PTC resistor 420 has risen, its cooling time for cooling to below a predetermined temperature requires at least ten minutes so the heat sense switch 430 is accordingly turned off until the PTC resistor 420 is cooled below the predetermined temperature. Thus, no current is supplied to the degaussing circuit for ten to fifteen minutes after the demagnetization operation.

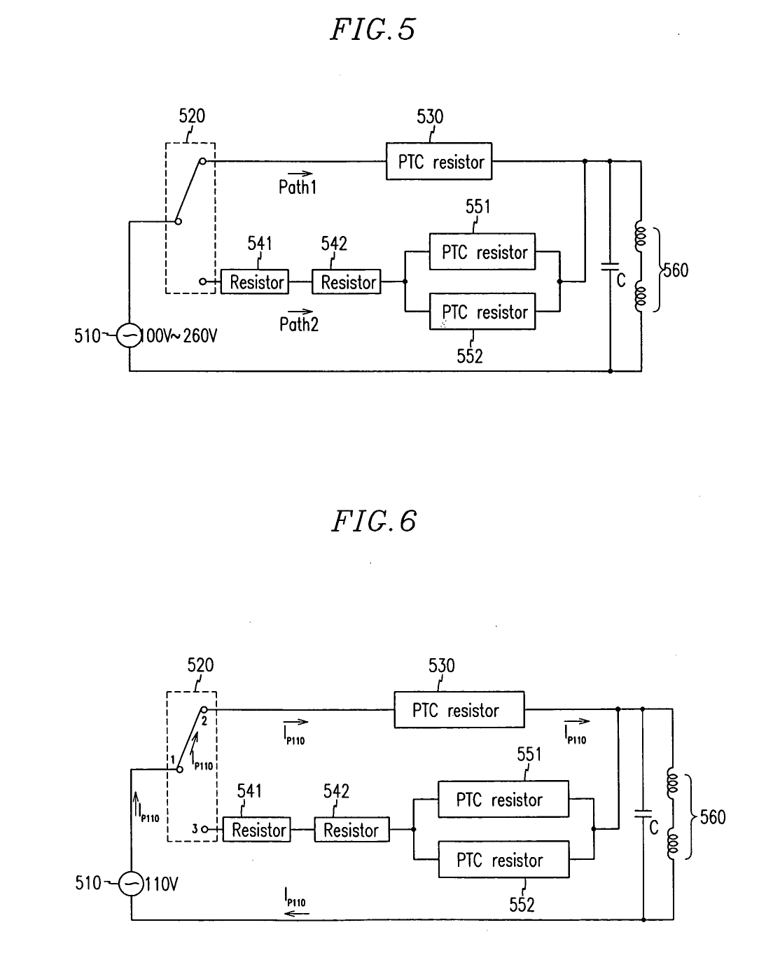

Referring to FIGS. 5 through 7, a CRT degaussing circuit according to a second preferred embodiment of the present invention will be described.

As shown in FIG. 5, the CRT degaussing circuit comprises an AC power source 510 for supplying one of 110V and 220V; a relay 520 for changing switch nodes according to the voltages supplied by the AC power source 510; a PTC resistor 530 forming a first path (Path 1); resistors 541 and 542 and PTC resistors 551 and 552 forming a second path (Path 2); and a capacitor C and a degaussing coil 560 coupled in parallel, and coupled in common to the first and second paths, for performing a demagnetization function on the metallic components of the CRT.

First, the AC power source 510 supplies the AC voltage of 110V or 220V to the degaussing circuit. The relay 520 selects the first or second path according to the voltage of the AC power source 510. In detail, the relay 520 selects the first path in the initial stage, and when the voltage of the AC power source 510 is 220V, the relay 520 senses this voltage and switches to the second path. If the first path is selected by the relay 520, the current flows to reach the degaussing coil 560 through the PTC resistor 530, and if the second path is selected, the current flows to reach the degaussing coil 560 through the resistors 541 and 542 and the PTC resistors 551 and 552. The resistors 541 and 542 are used for controlling the demagnetization current when the voltage of 220V is applied. In the preferred embodiment, each of the resistors 541 and 542 has a resistance of 4Ω, the PTC resistor 530 has a resistance of 1.5Ω, and each of the PTC resistors 551 and 552 has resistance of 4.5Ω. The resistances can be varied according to circuit designs.

FIG. 6 shows an equivalent circuit when the AC voltage of 110V is applied to the circuit of FIG. 5. In detail, when the AC power source 510 supplies the voltage of 110V, the relay 520 selects the first path to supply the current P110 to the degaussing coil 560 through the first path because the relay 520 connects its first and second inner nodes when the voltage of the AC power source 510 is 110V, and connects its first and third inner nodes when the voltage is 220V. The AC current P110 passing through the relay 520 is passed through the PTC resistor 530 for the voltage of 110V in the first current path so as to reach the degaussing coil 560. Thus, the desired demagnetization EMF occurs in the degaussing coil 560. Table 4 shows the specification and demagnetization EMF of the degaussing coil 560.

TABLE 4

| Degaussing coil | | | PTC | | | | | |
|---|---|---|---|---|---|---|---|---|
| coil | | coil | Internal | | | Input | Demagnetization EMF | |
| thickness | Turns | length | resistence | Inductance | resistor | voltage | Demagnetization | EMF |
| (mm) | (turns) | (mm) | ()Ω | (mH) | (Ω) | (V) | current(A) | (AT) |
| Φ1.1 | 66 | 3,700 | 2.3 | 12 | 1.5 | 110 | 37.4 | 4,940 |

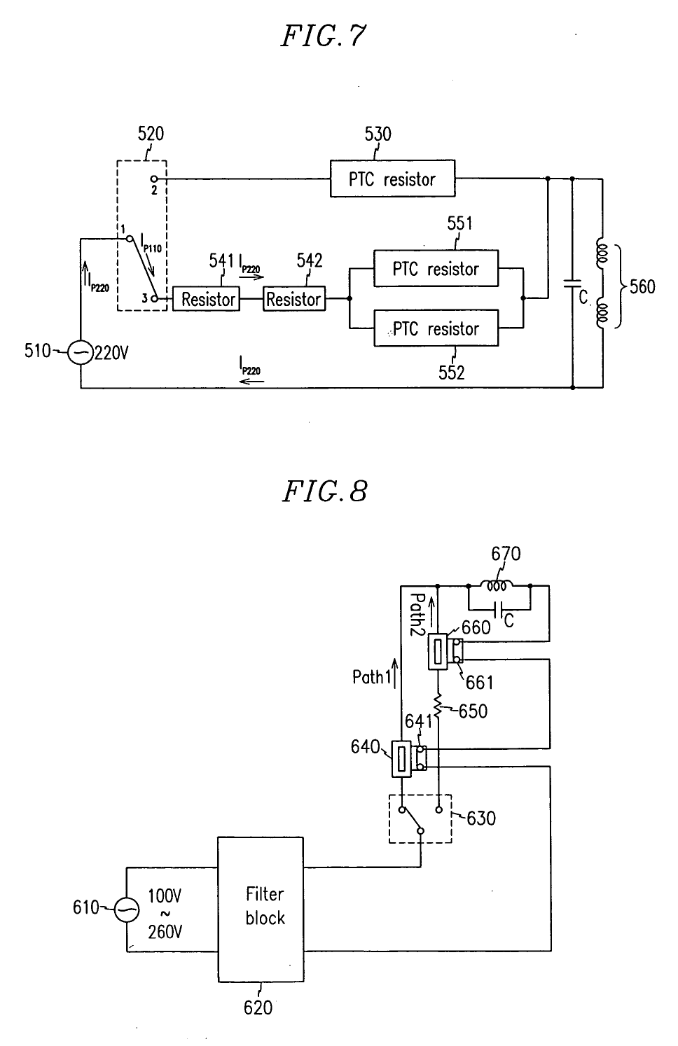

When the AC power source 510 outputs the voltage of 220V in the degaussing circuit of FIG. 6, the current path as shown in FIG. 7 is formed. That is, since the relay 520 connects its first and third inner nodes as shown in FIG. 7, the demagnetization current P220 is supplied to the degaussing coil 560 through the second path. Auxiliary resistors 541 and 542 and PTC resistors 551 and 552 for forming a demagnetization condition with the AC power of 220V are provided in the second path. Table 5 shows degaussing specifications and demagnetization EMF used for the circuit of FIG. 7.

TABLE 5

| | | | |
|---|---|---|---|
| | PTC | Aux. | |
| | resistor | resistor | |
| Degaussing coil | (Ω) | (Ω) | Demagnetization EMF |

| coil | | coil | Internal | | | | Input | | |
|---|---|---|---|---|---|---|---|---|---|
| thickness | Turns | length | resistance | Inductance | | | voltage | Demagnetization | EMF |
| (mm) | (turns) | ht (mm) | (Ω) | (mH) | | | (V) | current (A) | (AT) |
| Φ1.1 | 66 | 3,700 | 2.3 | 12 | 2.3 | 8.0 | 220 | 37.3 | 4,920 |

Comparing Tables 4 and 5, it is seen that the demagnetization EMF can have a constant value regardless of the voltage of the input AC power when the specifications of the degaussing coils are the same. This process can be achieved by selecting the resistances of the resistors or the PTC resistors formed in the first or second path according to the corresponding AC voltage.

Next, referring to FIGS. 8 thru 11, a CRT degaussing circuit according to a third preferred embodiment of the present invention will be described.

As shown in FIG. 8, the CRT degaussing circuit comprises: an AC power source 610 for supplying the voltage of 110V or 220V; a filter block 620 for preventing noise generated by the degaussing circuit from being fed back to the AC power source 610; a relay 630 for changing the switch nodes when the voltage supplied by the AC power source 610 is greater than 160V; a PTC resistor 640 forming a first path (Path 1); a resistor 650 and a PTC resistor 660 forming a second path (Path 2); a capacitor C and a degaussing coil 670 coupled in parallel and in common to the first and second paths for performing a demagnetization function on the metallic components of the CRT; and heat sense switches 641 and 661 attached as single bodies to the PTC resistors 640 and 660, respectively. The AC power source 610, the PTC resistor 640, the heat sense switch 641, the PTC resistor 660, the heat sense switch 661, and the degaussing coil 670 form a closed-loop circuit, and the heat sense switches 641 and 661 are coupled so as to turn on/off the current flow in the closed-loop circuit. The current transfer path of the closed-loop circuit starts at the AC power source 610, passes through one of the first and second paths and the degaussing coil 670, and reaches the heat sense switches 641 and 661.

When power is supplied to the degaussing circuit, the AC power source 610 outputs the AC power of 110V or 220V. The relay 630 selects one of the first and second paths according to the voltage of the AC power source 610. In detail, the relay 630 always selects the first path when the voltage of the AC power source 610 is less than 160V, and switches to the second path when the voltage of the AC power source 610 is greater than 160V. When the voltage of the AC power source 610 is less than 160V, the first path is maintained by the relay 630, and the current passes through the PTC resistor 640 to reach the degaussing coil 670. When the voltage of the AC power source 610 is greater than 160V, the second path is selected by the relay 630, and the current passes through the resistor 650 and the PTC resistor 660 to reach the degaussing coil 670. The resistor 650 is used for appropriately controlling the intensity of the demagnetization current when the voltage of 220V is supplied. In the preferred embodiment, the resistor 650 has resistance of 8Ω, the PTC resistor 640 has resistance of 1.5Ω, and the PTC resistor 660 has resistance of 2.3Ω. The resistances can be varied according to circuit designs.

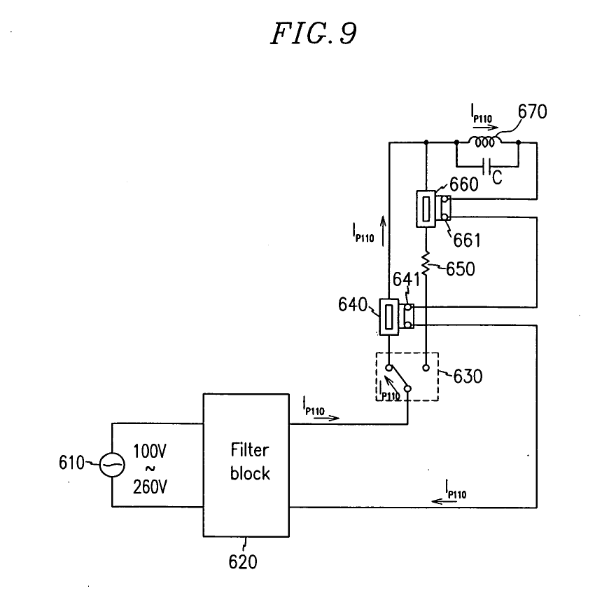

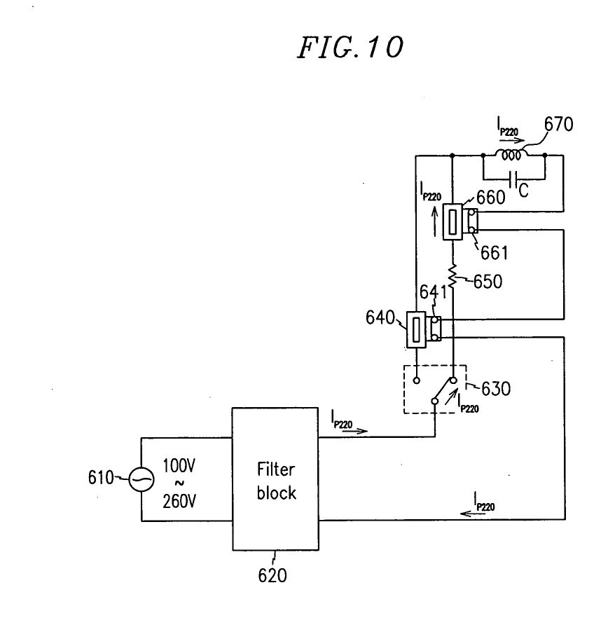

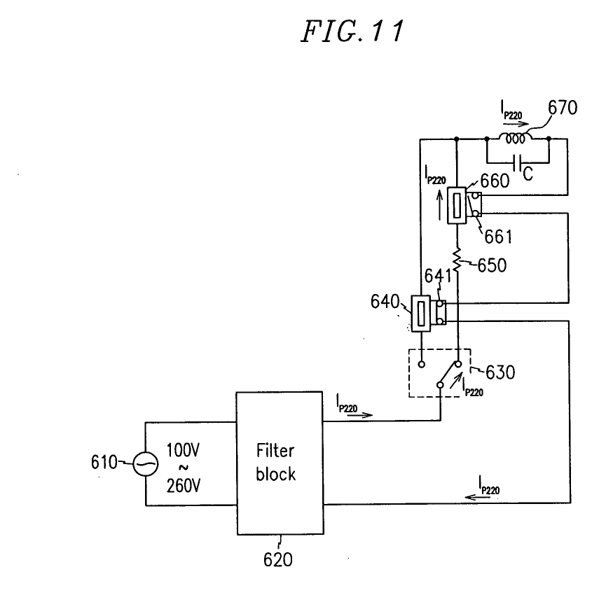

FIG. 9 shows an equivalent circuit when the AC voltage of 110V is supplied to the circuit of FIG. 8. In detail, when the AC power source 610 supplies the voltage of 110V, the relay 630 maintains the first path to supply the current P110 to the degaussing coil 670 through the first path.

The reason for this is that, when the voltage of the AC power source 610 is 110V, the voltage is less than the voltage of 160V which is a relay inner node switching voltage, and the relay 630 maintains the initial node state. When the voltage of the AC power source 610 is 220V, it is greater than the relay inner node switching voltage so as to switch the nodes. The AC current, having passed through the relay 630, passes through the PTC resistor 640 of the first path to reach the degaussing coil 670, and accordingly, the desired demagnetization EMF is generated in the degaussing coil 670.

When the voltage of the AC power source 610 is changed to the voltage of 220V in the degaussing circuit of FIG. 9, the current path as shown in FIG. 10 is formed. That is, since the relay 630 switches its inner nodes in FIG. 10, current P220 is supplied to the degaussing coil 670 through the second path. The resistor 650 and the PTC resistor 660 forming a demagnetization condition on the AC voltage of 220V are provided in the second path.

As shown in FIG. 11, when the current P220 flows to the PTC resistor 660 in the second path in the case where AC power source 610 outputs the voltage of 220V, the PTC resistor 660 is heated to raise its temperature. As the current continues to flow thereto, the resistance of the PTC resistor 660 increases, and the current finally becomes almost zero. In this instance, the heat sense switch 661 unified to the PTC resistor 660 is turned on from the initial cooled state so as to provide the current to the degaussing circuit. When the current continuously flows in this state, the PTC resistor 660 is heated, and in some cases, the surface temperature of the PTC resistor 660 instantly and steeply rises. The heat sense switch 661 is turned off when the temperature of the PTC resistor 660 exceeds a switch operation temperature so as to interrupt the current flow in the degaussing circuit. Also, the heat sense switch 661 is turned off until the PTC resistor 660 is cooled so as to reduce the surface temperature below a predetermined condition.

As described, by removing components including a microcomputer, a timer and a relay for controlling the operation time and the cooling time of the PTC resistors from the degaussing circuit of FIGS. 1 thru 3, the CRT degaussing circuit according to the preferred embodiments of FIGS. 4 thru 11 reduces the number of expensive components so as to cut costs, controls the demagnetization operation time to within ten seconds, and obtain sufficient cooling time through the heat sense switch attached to the PTC resistor, thereby maintaining the demagnetization function of the existing CRT and reducing the cost of the degaussing circuit.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. A cathode-ray tube (CRT) degaussing circuit, comprising:
an alternating current (AC) power source;
a positive temperature characteristic (PTC) resistor;
a heat sense switch, provided as a single unit with the PTC resistor, for controlling current flow in the degaussing circuit so that current is turned on and off according to a surface temperature of the PTC resistor; and
a degaussing coil for demagnetizing metallic components of the CRT when the current is applied;
wherein the AC power source, the PTC resistor, the degaussing coil, and the heat sense switch form a closed-loop circuit, and the heat sense switch is connected thereto so as to turn on and off the current flow in the closed-loop circuit.

2. The CRT degaussing circuit of claim 1, wherein a current transfer path of the closed-loop circuit starts at the AC power source, passes through the PTC resistor and the degaussing coil, and reaches the heat sense switch.

3. The CRT degaussing circuit of claim 1, wherein the CRT degaussing circuit is applied to a color selection apparatus of the CRT; and
wherein the color selection apparatus comprises a tension mask having a plurality of apertures and providing tension force in a short side direction of a face plate, and a mask frame having a pair of support members for supporting a long side of the tension mask and a pair of elastic members for connecting the support members into a single unit in the short side direction.

4. The CRT degaussing circuit of claim 1, wherein the degaussing coil has a ring format, a figure eight shape, and a top/down separable format.

5. A cathode-ray tube (CRT) degaussing circuit, comprising:
an alternating current (AC) power source for outputting one of 110V and 220V AC voltages;
a relay for changing switch nodes according to the AC voltages supplied by the AC power source;
a positive temperature characteristic (PTC) resistor forming a first current path when the 110V AC voltage is applied;
a resistor and a PTC resistor forming a second current path when the 220V AC voltage is applied; and
a capacitor and a degaussing coil coupled in common to the first and second current paths for performing a demagnetization function on metallic components of the CRT;
wherein the relay selects one of the first and second current paths according to the AC voltage supplied by the AC power source.

6. The CRT degaussing circuit of claim 5, wherein the capacitor and the degaussing coil are coupled in common to the first and second current paths, and are coupled in parallel.

7. The CRT degaussing circuit of claim 5, wherein the CRT degaussing circuit is applied to a color selection apparatus of the CRT; and
wherein the color selection apparatus comprises a tension mask having a plurality of apertures and providing tension force in a short side direction of a face plate, and a mask frame having a pair of support members for supporting a long side of the tension mask and a pair of elastic members for connecting the support members into a single unit in the short side direction.

8. The CRT degaussing circuit of claim 5, wherein the degaussing coil has a ring format, a figure eight shape, and a top/down separable format.

9. The CRT degaussing circuit of claim 5, further comprising a filter block disposed between the AC power source and the relay for preventing noise generated by the degaussing circuit from being fed back to the AC power source.

10. The CRT degaussing circuit of claim 5, further comprising a heat sense switch provided as a single unit with the PTC resistor;
wherein the heat sense switch interrupts current flow of the degaussing circuit when a temperature of the PTC resistor is greater than a predetermined value, and operates to maintain the interrupted current flow until the temperature decreases to a value below the predetermined value.

11. A cathode-ray tube (CRT) degaussing circuit, comprising:
an alternating current (AC) power source;
a positive temperature characteristic (PTC) resistor connected in series with the AC power source;
a degaussing coil connected in series with the AC power source and the PTC resistor for demagnetizing metallic components of the CRT when current is applied; and
control means associated with the PTC resistor for controlling current flow in the degaussing circuit by passing or interrupting the current dependent on a surface temperature of the PTC resistor.

12. The CRT degaussing circuit of claim 11, wherein the AC power source, the PTC resistor, the degaussing coil, and the control means form a closed-loop circuit.

13. The CRT degaussing circuit of claim 12, wherein a current transfer path of the closed-loop circuit starts at the AC power source, passes through the PTC resistor and the degaussing coil, and reaches the control means.

14. The CRT degaussing circuit of claim 11, wherein the control means comprises a heat sensing switch for sensing the surface temperature of the PTC resistor.

15. The CRT degaussing circuit of claim 14, wherein the heat sensing switch is integrally formed with the PTC resistor into a single unit.

16. A cathode-ray tube (CRT) degaussing circuit, comprising:
an alternating current (AC) power source for outputting one of a first voltage and a second voltage;
a first current path;
a second current path; and
a degaussing coil coupled in series with the AC power source and with the first and second current paths for performing demagnetization of metallic components of a CRT; and
relay means disposed in series between the AC power source, on one side, and the first and second current paths, on another side, for directing current along the first current path to the degaussing coil when the AC power source outputs the first voltage, and for directing the current along the second current path to the degaussing coil when the AC power source outputs the second voltage.

17. The CRT degaussing circuit of claim 16, wherein the first current path comprises a positive temperature characteristic (PTC) resistor, and the second current path comprises a PTC resistor in series with a resistor.

18. The CRT degaussing circuit of claim 16, wherein the first current path comprises a positive temperature characteristic (PTC) resistor, and the second current path comprises at least one resistor in series with at least one PTC resistor.

19. The CRT degaussing circuit of claim 18, wherein said at least one PTC resistor comprises two PTC resistors connected in parallel with each other to form a parallel arrangement in series with said at least one resistor.

20. The CRT degaussing circuit of claim 16, wherein the degaussing coil is coupled in common to the first and second current paths.

21. The CRT degaussing circuit of claim 16, further comprising a capacitor connected in parallel with the degaussing coil.
